(19) United States
(12) Patent Application Publication
(10) Pub. No.: US 2014/0087069 A1
(43) Pub. Date: Mar. 27, 2014

(54) METHOD FOR REPAIRING HOLLOW FIBER MEMBRANE

(71) Applicant: Cheil Industries Inc., Gumi-si (KR)

(72) Inventors: Ji Hye KIM, Uiwang-si (KR); Young Lim KOO, Uiwang-si (KR); Jin Min KIM, Uiwang-si (KR)

(21) Appl. No.: 13/921,035

(22) Filed: Jun. 18, 2013

(30) Foreign Application Priority Data
Sep. 26, 2012 (KR) 10-2012-0107435

(51) Int. Cl. B01D 65/10

(52) U.S. Cl. CPC B01D 65/108
USPC 427/140; 264/36.11

(57) ABSTRACT

A method for repairing a hollow fiber membrane in a module in which ends of a plurality of hollow fiber membranes are secured to a side of the module. A method for repairing a hollow fiber membrane in a module includes bringing a filler material that is in a solid phase into contact with a damaged portion of the hollow fiber membrane, and heating a filler contact site to join the filler material to the hollow fiber membrane, and the filler material is in solid phase.

### CROSS-REFERENCE TO RELATED APPLICATION

This application claims priority to and the benefit of Korean Patent Application No. 10-2012-0107435, filed on Sep. 26, 2012 in the Korean Intellectual Property Office, the entire content of which is incorporated herein by reference.

### FIELD

Aspects of embodiments of the present invention relate to a method for repairing a hollow fiber membrane.

### BACKGROUND

Generally, a hollow fiber membrane module is manufactured using hundreds to thousands of hollow fiber membranes. However, the module may be subject to damage, such as holes, tearing or the like, to some of the hollow fiber membranes in the course of manufacture, use, or transfer. When a single hollow fiber membrane is damaged in the module, filtered water is contaminated, causing serious problems.

Thus, since it is difficult to replace the module itself when the hollow fiber membrane is damaged, it is necessary or preferable to repair the damaged hollow fiber membrane.

In a typical repair method, a damaged portion is cut, and a cut hollow hole is blocked to prevent outflow of filtered water through the damaged hollow fiber membrane. To block the hollow hole, liquid silicone is injected into the damaged membrane and cured therein. Alternatively, a small nail or pin may be inserted into the hollow hole.

However, the liquid silicone method has problems in that a cassette of the relevant module must be placed on a worktable during repair operation due to fluidity of the liquid silicone, and in that repair is carried out for a long time due to a long curing duration, thereby causing burdens and reducing productivity.

The method using the small nail or pin also has a problem in that, when the hollow fiber membrane is a reinforcing membrane, a gap can be created between the membrane and the nail or pin, causing contamination of filtered water. Particularly, in a pressurized module having a housing, since a fine edge or blade is present in the membrane, a narrow space may be created between the fine edge or blade and a repair material, thereby making it difficult to achieve complete blocking of a hollow hole.

Therefore, there is a need for a method for repairing a hollow fiber membrane, which allows easy and rapid repair of the hollow fiber membrane on-site in a reliable manner through complete sealing without moving to a worktable.

### SUMMARY

According to an aspect of embodiments of the present invention, a method is provided for repairing a hollow fiber membrane, which allows easy and rapid repair of hollow fiber membranes on-site in a reliable manner through complete sealing without moving to a worktable, and which may ensure safety as a water-purifying membrane. Further, according to an aspect of embodiments of the present invention, a method is provided for repairing a hollow fiber membrane in a simple, rapid, and safe manner.

According to one or more embodiments of the present invention, a method for repairing a hollow fiber membrane in a module in which ends of a plurality of hollow fiber membranes are secured to a side of the module includes: bringing a filler material into contact with a damaged portion of the hollow fiber membrane; and heating a filler contact site to join the filler material to the hollow fiber membrane, wherein the filler material is in a solid phase.

The filler material may include at least one of a powder, a bead, a pellet, a spherical particle, a gel, or a paste.

The filler material may include at least one of natural rubber, natural silicone, gelatin, agar, chicle, starch glue, or solid wax.

In one embodiment, the filler material may be brought into direct contact with the damaged portion of the hollow fiber membrane,

The filler contact site may be heated to a temperature of about 80° C. to about 140° C.

The module may be a pressurized hollow fiber membrane module.

The hollow fiber membrane may be a filament-reinforced hollow fiber membrane.

According to one or more embodiments of the present invention, a method for repairing a hollow fiber membrane in a module in which ends of a plurality of hollow fiber membranes are secured to a side of the module includes: cutting a damaged portion of the hollow fiber membrane; inserting a filler material into a cut face of the hollow fiber membrane to contact the hollow fiber membrane; and heating a filler contact site to join the filler material to the hollow fiber membrane, wherein the filler material is in a solid phase.

### BRIEF DESCRIPTION OF THE DRAWINGS

FIG. 1 is a schematic view of a hollow fiber membrane module in which a hollow fiber membrane is damaged.

FIG. 2 is a schematic view showing a method for repairing a damaged hollow fiber membrane according to an embodiment of the present invention.

FIG. 3 is a schematic view showing a method for repairing a damaged hollow fiber membrane according to another embodiment of the present invention.

FIG. 4 is an enlarged view of a region “A” of FIG. 3.

### DETAILED DESCRIPTION

Some exemplary embodiments of the present invention are described herein with reference to the accompanying drawings; however, embodiments of the present invention may be embodied in different forms and should not be construed as limited to the embodiments set forth herein. As those skilled in the art would realize, the described embodiments may be modified in various different ways, all without departing from the spirit or scope of the present invention. Accordingly, the drawings and description are to be regarded as illustrative in nature and not restrictive.

FIG. 1 is a schematic view of a hollow fiber membrane module 100 in which a hollow fiber membrane is damaged. Such a module may be manufactured by arranging a plurality of hollow fiber membranes 10 and securing ends of the hollow fiber membranes 10 to one side of the module. When a certain hollow fiber membrane 10 of the module 100 has a damaged portion L, filtered water passing through the damaged membrane may be contaminated. Thus, it is necessary or preferable to repair the damaged membrane.

Embodiments of the present invention relate to a method for repairing a hollow fiber membrane in a module in which ends of a plurality of hollow fiber membranes are secured to one side of the module. The method includes: bringing a filler material into contact with a damaged portion of a hollow fiber membrane; and heating a filler contact site to join the filler material to the hollow fiber membrane, wherein the filler material is in solid phase.

The term “damaged portion” as used herein includes all sites at which leakage, breakage, puncturing, tearing, a cut, or the like occurs such that a relevant hollow fiber membrane cannot function appropriately, and includes the meaning of a cut face of the hollow fiber membrane that is damaged and/or cut.

In one or more embodiments of the present invention, a solid-state filler material is employed. Thus, there is no problem of fluidity caused by liquid silicone, as in the related art, and a cartridge including a damaged membrane can be repaired in-place without moving to a separate worktable.

The terms “solid-state” or “solid phase” as used herein include a solid phase or a semisolid phase.

The filler material may have, for example, a powder, bead, pellet, spherical particle, gel, or paste shape. When work convenience is taken into account, the filler material may be beads, pellets, or spherical particles. As used herein, “spherical shape” includes a substantially spherical shape, and thus includes an oval shape. The pellets may include a cylindrical shape, a hexahedral shape, a pyramidal shape, a rod shape, and the like. The particles may have a uniform, substantially uniform, or non-uniform size.

The filler material may include, for example, at least one selected from among natural rubber, natural silicone, gelatin, agar, chicle, starch glue, or solid wax. In embodiments of the present invention, these materials are eco-friendly materials that are not harmful to the human body when dissolved in filtered water, whereby the repaired membrane can be safely used as a water-purifying membrane.

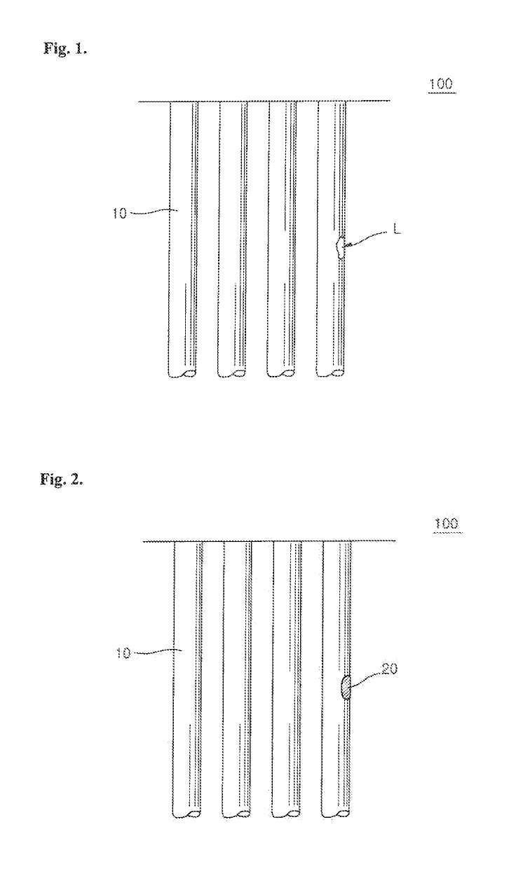

FIG. 2 is a schematic view showing a method for repairing a damaged hollow fiber membrane according to an embodiment of the present invention. In one embodiment, a filler material 20 is brought into direct contact with a damaged portion of the hollow fiber membrane. The filler material 20 may be applied to the damaged portion L, and heated to join the filler material 20 to the membrane 10.

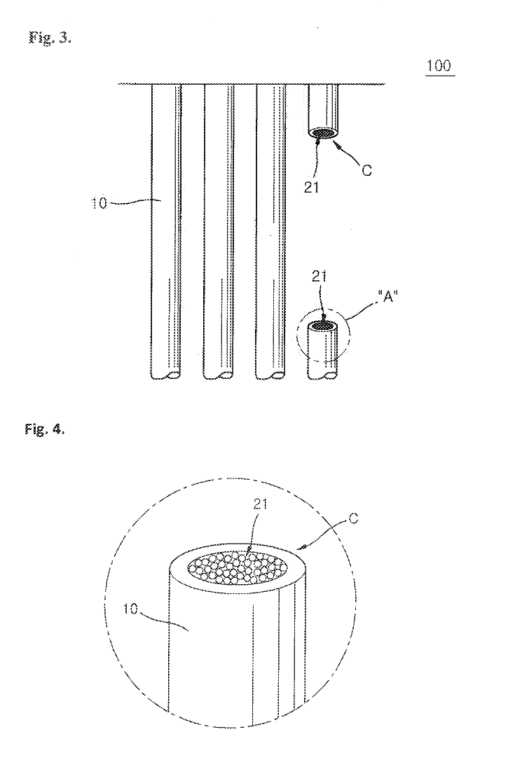

FIG. 3 is a schematic view showing a method for repairing a damaged hollow fiber membrane according to another embodiment of the present invention, and FIG. 4 is an enlarged view of a region “A” of FIG. 3. When the hollow fiber membrane 10 is cut at a site around the damaged portion, two cut faces C are formed. Then, a filler material 21 is inserted into the cut faces C. Heat may be applied thereto to join the filler material 21 to the membrane 10.

The filler material contact site may be heated at temperatures of about 80° C. to about 140° C. In this temperature range, the hollow fiber membrane and the filler material may be joined to each other without damaging the hollow fiber membrane.

Embodiments of the method of the present invention may also be applied to a pressurized hollow fiber membrane module, which allows a limited repair method due to a configuration of a housing.

The hollow fiber membrane may be a single hollow fiber membrane or a reinforced hollow fiber membrane. Embodiments of the method of the present invention may be applied to reinforced hollow fiber membranes which are otherwise difficult to repair.

The present invention is described in further detail below with reference to some examples of the present invention. It should be understood that these examples are provided for illustration only and are not to be construed in any way as limiting the scope of the present invention. Description of details that will be apparent to those skilled in the art is omitted.

### EXAMPLES

### Example 1

As shown in FIGS. 3 and 4, a hollow fiber membrane having a damaged portion was cut and 0.15 g of a solid wax was inserted into the opposite cut faces formed by cutting. Next, a portion around the cut faces was heated three times to 80° C. for 5 seconds to join the solid wax to the hollow fiber membrane, followed by removal of a damaged portion.

### Comparative Example 1

A hollow fiber membrane having a damaged portion was cut and liquid silicone was inserted into the opposite cut faces formed by cutting. Although the liquid silicon could be inserted into a lower cut face, it could not be inserted into an upper cut face since the liquid silicone flowed downward.

Although some embodiments have been described herein, these embodiments are described and shown by way of illustration only, and it will be apparent to those skilled in the art that various modifications, changes, alterations, and equivalent embodiments can be made without departing from the spirit and scope of the present invention.

What is claimed is:

1. A method for repairing a hollow fiber membrane in a module in which ends of a plurality of hollow fiber membranes are secured to a side of the module, the method comprising:
bringing a filler material into contact with a damaged portion of the hollow fiber membrane; and
heating a filler contact site to join the filler material to the hollow fiber membrane, wherein the filler material is in a solid phase.

2. The method according to claim 1, wherein the filler material comprises at least one of a powder, a bead, a pellet, a spherical particle, a gel, or a paste.

3. The method according to claim 2, wherein the filler material comprises at least one of natural rubber, natural silicone, gelatin, agar, chicle, starch glue, or solid wax.

4. The method according to claim 1, wherein the filler material is brought into direct contact with the damaged portion of the hollow fiber membrane.

5. The method according to claim 1, wherein the filler contact site is heated to a temperature of about 80° C. to about 140° C.

6. The method according to claim 1, wherein the module is a pressurized hollow fiber membrane module.

7. The method according to claim 1, wherein the hollow fiber membrane is a filament-reinforced hollow fiber membrane.

8. A method for repairing a hollow fiber membrane in a module in which ends of a plurality of hollow fiber membranes are secured to a side of the module, the method comprising:
cutting a damaged portion of the hollow fiber membrane;
inserting a filler material into a cut face of the hollow fiber membrane to contact the hollow fiber membrane; and
heating a filler contact site to join the filler material to the hollow fiber membrane, wherein the filler material is in a solid phase.

9. The method according to claim 8, wherein the filler material comprises at least one of a powder, a bead, a pellet, a spherical particle, a gel, or a paste.

10. The method according to claim 9, wherein the filler material comprises at least one of natural rubber, natural silicone, gelatin, agar, chicle, starch glue, or solid wax.

11. The method according to claim 8, wherein the filler contact site is heated to a temperature of about 80° C. to about 140° C.

12. The method according to claim 8, wherein the module is a pressurized hollow fiber membrane module.

13. The method according to claim 8, wherein the hollow fiber membrane is a filament-reinforced hollow fiber membrane.
